(19) United States
(12) Patent Application Publication
(10) Pub. No.: US 2026/0003704 A1
(43) Pub. Date: Jan. 1, 2026

(54) Memory Probing for Proactive Error Detection

(71) Applicant: Arista Networks, Inc., Santa Clara, CA (US)

(72) Inventors: Suhas Raghunath Joshi, San Jose, CA (US); Venkata Kishore Madhbhaktula, Fremont, CA (US); Rajnish Gupta, Saratoga, CA (US)

(21) Appl. No.: 18/755,522

(22) Filed: Jun. 26, 2024

(51) Int. Cl. G06F 11/07

(52) U.S. Cl. CPC G06F 11/0751; G06F 11/073; G06F 11/0793

(57) ABSTRACT

A network device may include data plane processing circuitry and memory circuitry accessible by the data plane processing circuitry to perform traffic processing operations. The memory circuitry may sometimes experience memory errors such as bit flips. One or more processors on the network device may access the memory circuitry, in parallel with the data plane processing circuitry accessing the memory circuitry, to detect and correct these memory errors more quickly, thereby reducing disruptions to traffic processing operations caused by memory errors.

### BACKGROUND

A communications system can include network devices that are interconnected to form a network for conveying network traffic from source devices to destination devices. To appropriately process network traffic received at a network device, the network device may include memory circuitry that stores traffic forwarding decision data. The network device and/or other elements in the network may also include memory circuitry that stores other types of data.

### BRIEF DESCRIPTION OF THE DRAWINGS

FIG. 1 is a diagram of an illustrative networking system having one or more network devices in accordance with some embodiments.

FIG. 2 is a diagram of an illustrative network device in accordance with some embodiments.

FIG. 3 is a diagram of illustrative memory circuitry accessible by data plane processing circuitry in accordance with some embodiments.

FIG. 4 is a diagram of illustrative memory circuitry having an error detection functionality in accordance with some embodiments.

FIG. 5 is a diagram of illustrative processing circuitry configured to proactively probe memory circuitry to facilitate memory error detection in accordance with some embodiments.

FIG. 6 is a diagram of an illustrative scheme for preferential memory access in accordance with some embodiments.

FIG. 7 is a flowchart of illustrative operations for detecting a memory error in accordance with some embodiments.

### DETAILED DESCRIPTION

A network may include interconnected network devices that convey network traffic between end hosts or generally between devices. A network device may include a packet processor (e.g., data plane processing circuitry) and memory circuitry that stores traffic processing decision data accessible and usable by the packet processor to process any received network traffic (e.g., to determine any modifications to be applied to the network traffic, to determine how the network traffic should be forwarded, and/or to generally determine any actions that should be taken responsive to the received network traffic).

Memory circuitry such as the memory circuitry that stores traffic processing decision data may be susceptible to memory errors such as soft errors caused by single-event upsets. Without correction of memory errors, network traffic handled by the packet processor may be undesirably dropped when the portion of memory storing the traffic processing decision data for processing the network traffic is affected by the memory errors. Because the detection of a memory error occurs when the memory portion containing the error is accessed by the packet processor to process network traffic and because error correction can take a non-trivial period of time thereafter, the processing of network traffic can be undesirably disrupted during this period of time. Accordingly, it may be desirable to provide mechanism(s) by which memory errors (e.g., memory errors in memory circuitry accessible by control plane processing circuitry and/or data plane processing circuitry) are proactively detected and corrected ahead of use of the affected traffic processing decision data by the packet processor. If desired, the mechanism(s) for proactively detecting and correcting memory errors may be implemented for memory circuitry in any suitable system and/or in any suitable context.

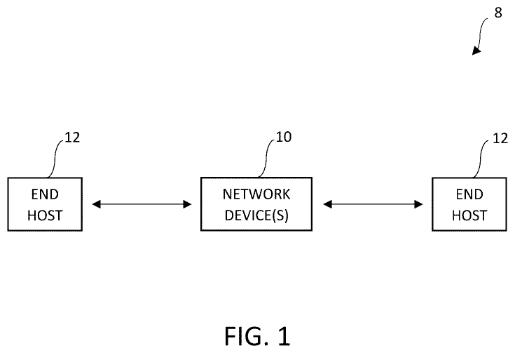

In illustrative configurations described herein as an example, the memory circuitry of the network device may include error detection circuitry. The network device may include one or more processors that probe the memory circuitry to detect memory errors (e.g., one or more bit flips). In particular, probing the memory circuitry may involve sequentially accessing (e.g., reading) memory elements of the memory circuitry while the packet processor accesses the memory circuitry for normal traffic processing. Any bits affected by memory errors may be detected by error detection circuitry and indications of the memory errors may be provided to the one or more processors for error correction. Because this type of detection and correction can occur prior to the use of the otherwise corrupted or erroneous data by the packet processor, disruption to traffic processing caused by memory errors can be reduced. An illustrative networking system that provides mechanism(s) for facilitating proactive memory error detection (e.g., in the manner described above) is shown in FIG. 1.

In the example of FIG. 1, the networking system may include a communications network 8. Network 8 may be implemented to span various geographical locations or generally be implemented with any suitable scope. As examples, network 8 may include, be, or form part of one or more local segments, one or more local subnets, one or more local area networks (LANs), one or more campus area networks, a wide area network, etc. In general, network 8 may include one or more wired portions with network devices interconnected based on wired technologies or standards such as Ethernet (e.g., using copper cables and/or fiber optic cables) and, if desired, one or more wireless portions implemented by wireless network devices (e.g., to form wireless local area networks (WLANs)). If desired, network 8 may include internet service provider networks (e.g., the Internet) or other public service provider networks, private service provider networks (e.g., multiprotocol label switching (MPLS) networks), and/or may include other types of networks such as telecommunication service provider networks.

Network 8 can include networking equipment forming a variety of network devices that interconnect and convey network traffic between devices such as end hosts. These network devices of network 8 such as network device(s) 10 may each be a switch (e.g., a multi-layer (Layer 2 and Layer 3) switch or a single-layer (Layer 2) switch), a bridge, a router, a gateway, a hub, a repeater, a firewall, a wireless access point, a network device serving other networking functions, management equipment that manages and controls the operation of one or more of these network devices, a network device that includes the functionality of two or more of these devices, or another type of network device.

Network devices(s) 10 of network 8 may receive network traffic from one or more end hosts 12 and may appropriately process the received network traffic to forward the network traffic to one or more end hosts 12. Host devices or host equipment that implement end hosts 12 of network 8 may include computers, servers, portable electronic devices such as cellular telephones and laptops, other types of specialized or general-purpose host computing equipment (e.g., running one or more client-side and/or server-side applications), network-connected appliances or devices that serve as input-output devices and/or computing devices in a distributed networking system, devices used by network administrators (sometimes referred to as administrator devices), network service or analysis devices, management equipment that manages and controls the operation of one or more of other end hosts and/or network devices, and/or other types of devices or equipment.

In some instances, network device(s) 10 may also receive and process network traffic that originates from (e.g., generated by) network devices (e.g., some peer network devices 10) and/or from other network elements of network 8. In general, network device(s) 10 may be configured to appropriately process received network traffic, regardless of the source, to determine appropriate actions to take on the received network traffic (e.g., whether to forward or to drop network traffic, how to forward (egress) the network traffic, whether or not the network traffic or more specifically the header fields therein should be modified, how the header fields are to be modified, etc.). To facilitate the determination of appropriate actions for different portions of network traffic (e.g., different types of packets in different network flows) or generally to facilitate network device operations, each network device 10 may include memory circuitry that stores corresponding data usable to make these determinations and/or other types of data.

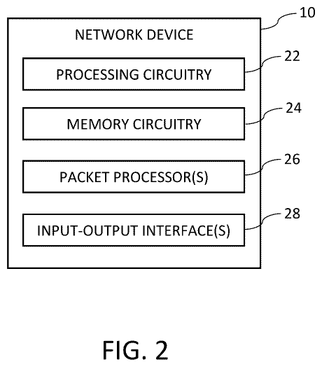

FIG. 2 is a diagram of an illustrative implementation of a network device. Configurations in which a network device of the type described in connection with FIG. 2 implements one or more of network device(s) 10 in FIG. 1 are described herein as an example.

As shown in FIG. 2, network device 10 may include processing circuitry 22, memory circuitry 24, one or more packet processors 26, and input-output interfaces 28 (e.g., formed using interface circuitry and one or more physical ports). In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 22 may run (e.g., execute) a network device operating system and/or other software/firmware that is stored on memory circuitry 24 communicatively coupled to and accessible by processing circuitry 22. Memory circuitry 24 may include one or more non-transitory (tangible) computer-readable storage media that store the operating system software and/or any other software code, sometimes referred to as program instructions, software, data, instructions, or code. As an example, the network device control plane operations described herein and performed by network device 10 may be stored as (software) instructions on the one or more non-transitory computer-readable storage media (e.g., in portion(s) of memory circuitry 24). The corresponding processing circuitry (e.g., one or more processors of processing circuitry 22) may process (e.g., execute) the respective instructions to perform the corresponding network device control plane operations.

Memory circuitry 24 may include non-volatile memory (e.g., flash memory, electrically-programmable read-only memory, a solid-state drive, hard disk drive storage, etc.), volatile memory (e.g., static random-access memory or dynamic random-access memory), removable storage devices (e.g., storage devices removably coupled to device 10), and/or other types of memory circuitry.

Processing circuitry 22 and at least the portion(s) of memory circuitry 24 as described above may sometimes be referred to collectively as control circuitry (e.g., collectively implementing a control plane of network device 10). Accordingly, processing circuitry 22 may sometimes be referred to as control plane processing circuitry 22 or control plane processor(s) 22. As just a few examples, processing circuitry 22 may execute network device control plane software such as operating system software, routing policy management software, routing protocol agents or processes, routing information base agents, and other control software, may be used to support the operation of protocol clients and/or servers (e.g., to form some or all of a communications protocol stack such as an Internet Protocol (IP) and Transmission Control Protocol (TCP) stack), may be used to support the operation of packet processor(s) 26, may store packet forwarding information, may execute packet processing software, and/or may execute other software instructions that control the functions of network device 10 and the other components therein.

Packet processor(s) 26 may be used to implement a data plane or forwarding plane of network device 10 and may therefore sometimes be referred to herein as data plane processor(s) 26 or data plane processing circuitry 26. Packet processor(s) 26 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 26 may receive incoming (ingress) network traffic via network interfaces 28 implemented on exterior-facing ports (and/or via internal interfaces), parse and analyze the received network traffic, process the network traffic based on traffic processing decision data (e.g., packet forwarding decision data in a forwarding information base, routing data in a routing information base, data in another type of routing table, data in accordance with network protocol(s), and/or data in accordance with a forwarding or other network policy such as an access control list (ACL) policy), and selectively modify and forward (or drop) the network traffic based on the traffic processing decision data.

To interact with external devices, external systems, and/or users, network device 10 may include input-output interfaces 28 formed from corresponding input-output devices (sometimes referred to as input-output circuitry or interface circuitry). Input-output interfaces 28 may include different types of communication interfaces such as Ethernet interfaces (e.g., formed from one or more Ethernet ports), optical interfaces (e.g., formed from removable optical modules containing optical transceivers), Bluetooth interfaces, Wi-Fi interfaces, and/or other network interfaces for connecting device 10 to the Internet, a local area network, a wide area network, a mobile network, generally network device(s) in these networks, and/or other computing equipment (e.g., end hosts, server equipment, user devices, etc.).

Some input-output interfaces 28 (e.g., those based on wireless communication) may be implemented using wireless communication circuitry (e.g., antennas, radio-frequency transceivers, radios, etc.). Some input-output interfaces 28 (e.g., those based on wired communication) may be implemented using physical ports. These physical ports may be configured to physically couple to and/or electrically connect to corresponding mating connectors of external components or equipment (e.g., cables, pluggable optical transceiver modules, etc.). Different ports may have different form-factors to accommodate different cables, different modules, different devices, or generally different external equipment.

As described above in connection with FIG. 2, memory circuitry 24 may include at least first memory circuitry that stores software instructions executable by control plane processing circuitry 22 and second memory circuitry that stores traffic processing decision data. The first memory circuitry may be integrated with one or more processors of processing circuitry 22 and/or may be implemented as discrete memory circuitry separate from the one or more processors of processing circuitry 22, and may generally be communicatively coupled to processing circuitry 22. The second memory circuitry may be integrated with one or more packet processors 26 and/or may be implemented as discrete memory circuitry separate from the one or more packet processors 26, and may generally be communicatively coupled to the one or more packet processor(s) 26 (and processing circuitry 22).

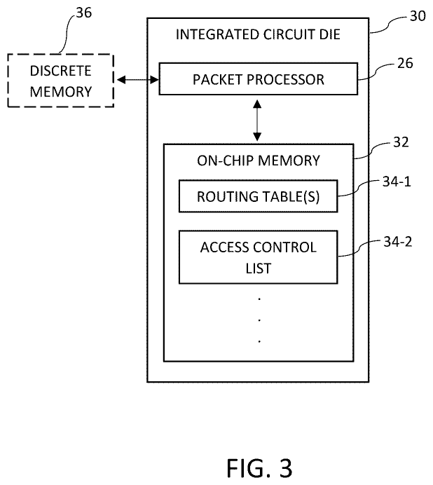

FIG. 3 is a diagram of an illustrative packet processor communicatively coupled to one or more types of memory circuitry. Configurations in which packet processor(s) 26 and at least a portion of memory circuitry 24 in FIG. 2 are implemented in the manner described in connection with FIG. 3 are described herein as illustrative examples.

As shown in FIG. 3, a packet processor 26 may be implemented on an integrated circuit die such as integrated circuit die 30 (sometimes referred to as die 30 or chip 30). The portion of memory circuitry 24 communicatively coupled to and accessible by packet processor 26 may be implemented as part of integrated circuit die 30, e.g., as on-chip memory 32 (sometimes referred to as on-chip memory circuitry 32 or memory circuitry 32). Memory circuitry 32 may store traffic processing decision data such as data in table entries of one or more routing tables 34-1 (e.g., forwarding information base(s), routing information base(s), etc.), data for implementing access control list(s) (ACLs) 34-2, and/or other types of data usable by packet processor 26 in making traffic processing decisions. If desired, memory circuitry 32 may store other content (e.g., state information, error detection bits, etc.) in addition to or instead of some or all of the traffic processing decision data.

Instead of or in addition to on-chip memory circuitry 32, discrete memory 36 may be used to implement the portion of memory circuitry 24 communicatively coupled to and accessible by packet processor 26. Discrete memory 36 (sometimes referred to as discrete memory circuitry 36 or memory circuitry 36) may be implemented on an integrated circuit die separate from integrated circuit die 30 on which packet processor 26 is implemented. Memory circuitry 36 may store any combination of the different types of data described to be stored by memory circuitry 32, instead of or in addition to the same data being stored by memory circuitry 32. If desired, dies for memory circuitry 36 and packet processor 26 may be implemented within the same integrated circuit package or may generally be mounted to the same printed circuit substrate.

Configured in this manner, packet processor 26 (e.g., a packet processing engine or a packet processing pipeline) may receive network traffic (e.g., in the form of packets) and may access the portion of memory circuitry 24 containing traffic processing decision data (e.g., may access memory circuitry 32 and/or memory circuitry 36) to appropriately process the received network traffic. As just a few examples, based on the traffic processing decision data, packet processor 26 may modify the header information of the network traffic, may generate metadata for the network traffic, may forward the network traffic to another component of network device 10 (e.g., control plane processing circuitry 22) and/or to an egress interface (e.g., interface 28), may drop the network traffic, and/or may take any other suitable actions (e.g., update network device state information such as a counter, mirror the network traffic, etc.).

Any suitable types of memory circuitry may be used to implement memory circuitry 32 and memory circuitry 36. Configurations in which memory circuitry 32 includes static random-access memory (SRAM) and memory circuitry 36 includes dynamic random-access memory (DRAM) (e.g., synchronous dynamic random-access memory (SDRAM) such as high bandwidth memory (HBM)) are sometimes described herein as illustrative examples.

The portion of memory circuitry 24 accessible by packet processor 36 (e.g., memory circuitry 32 and/or memory circuitry 36) and/or other portions of memory circuitry 24, and more generally memory circuitry in other devices of network 8 may be susceptible to memory errors such as soft errors. In particular, these soft memory errors may include one or more bit flips at corresponding location(s) in memory caused by single-event upsets (e.g., resulting from incident cosmic rays, other energetic particles, etc.).

Configurations in which content stored on memory circuitry 24, or more specifically on on-chip memory circuitry 32, experiences memory errors that are subsequently detected and corrected are sometimes described herein as an illustrative example. In general, memory errors occurring at any memory circuitry (e.g., discrete memory circuitry 36, other portions of memory circuitry 24, memory circuitry in other network elements of network 8, etc.) may similarly be detected and corrected.

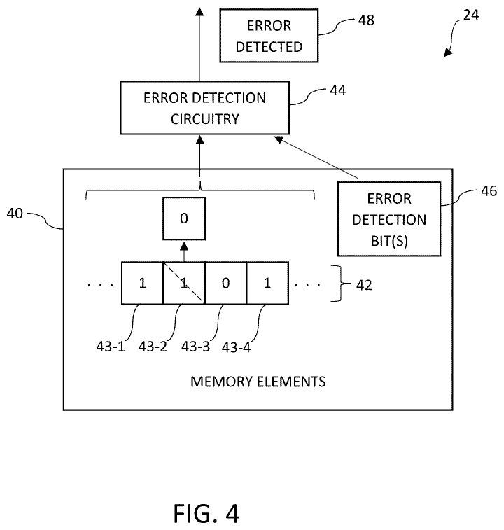

FIG. 4 is a diagram of illustrative memory circuitry (e.g., a portion of memory circuitry 24 such as memory circuitry 32 and/or memory circuitry 36) having error detection capabilities. In particular, memory circuitry 32 and/or memory circuitry 36 of FIG. 3 may include error detection capabilities and be implemented in the manner described in connection with FIG. 4.

As shown in FIG. 4, the portion of memory circuitry 24 may include memory elements 40 (e.g., memory cells arranged in rows and columns of a memory array or in any other suitable arrangement). Memory elements 40 may store pieces of data such as data 42 (e.g., data in an entry of a routing table 34-1, data in an entry corresponding to access control list 34-2, other traffic processing decision data, or other data usable by packet processor 26).

Data 42 may be stored as binary or bit values (i.e., a ‘0’ value or a ‘1’ value) in memory elements 40 at corresponding memory locations 43 (e.g., bit positions 43) of the memory circuitry. In the example of FIG. 4, the values of data 42 as intended (e.g., as programmed or stored by processing circuitry 22 as the desired traffic processing decision data) may have a value of ‘1’ at memory location 43-1 (e.g., at a first memory element or cell), may have a value of ‘1’ at memory location 43-2 (e.g., at a second memory element or cell), may have a value of ‘0’ at memory location 43-3 (e.g., at a third memory element or cell), and may have a value of ‘1’ at memory location 43-4 (e.g., at a fourth memory element or cell).

These binary values may be susceptible to single-event upsets that flip their values, causing memory errors. In the example of FIG. 4, the memory element for memory location 43-2 may experience a memory error (e.g., a single-event upset) that changes (flips) its stored value from “1” to an erroneous value of ‘0’. This error may be left undetected until the value at bit position 43-2 is accessed (e.g., when data 42 representing a routing table entry such as a forwarding information base entry or a routing information base entry, the access control list entry, or other traffic forwarding decision data is accessed) by packet processor 26 to process corresponding network traffic.

In particular, when packet processor 26 accesses (e.g., reads) data 42 (and therefore the faulty value at bit position 43-2) for traffic processing, error detection circuitry 44 for this portion of memory circuitry 24 (e.g., for memory circuitry 32 and/or memory circuitry 36) may validate the data 42 being accessed before providing packet processor 26 with data 42. During this validation process, error detection circuitry 44 may identify and obtain one or more (expected) error detection bits 46 associated with data 42 from storage. As examples, error detection bits 46 may include parity bits or error correction code (ECC) bits for data 42. While error detection bits 46 are shown in the example of FIG. 4 to be stored in the same memory elements as data 42, this is merely illustrative. If desired, error detection bits 46 may be stored in a memory array different from the memory array containing memory elements 40.

Error detection circuitry 44 may further calculate error detection bit(s) based on the current state (of bits) for data 42, may compare the calculated error detection bit(s) with expected error detection bit(s) 46 to determine whether there is a mismatch between the calculated bits and the expected bits. Responsive to a mismatch, which indicates one or more memory errors in the data being accessed, error detection circuitry 44 may provide an indication 48 of a detected error (e.g., an indication containing the bit position(s) of the memory error(s) if known and/or other information about the detected error) to packet processor 26 (e.g., via a memory controller integrated with packet processor 26 on die 30).

While the memory error(s) remain uncorrected, network traffic (that would have been processed using data 42) may be dropped by packet processor 26 (e.g., in a configuration where the memory circuitry does not include error correction capability or otherwise cannot compensate for the erroneous bit(s) in data 42 by outputting corrected bit(s)). Even for memory circuitry that includes error correction capability (e.g., implemented as part of error detection circuitry 44, which is then referred to sometimes as error detection and correction circuitry 44), the error correction capability may be limited (e.g., only a one-bit flip may be corrected by outputting the flipped bit instead of the stored faulty bit). However, it may still be desirable to correct the stored fault bit, which is left untouched by the error correction circuitry (e.g., error detection and correction circuitry 44).

While processing circuitry 22 may subsequently receive an indication of the detected memory error(s) from packet processor 26 and correct the error(s) (e.g., overwrite the errors with correct data), this entire process from when the error is detected to when the error is finally corrected can take some time, possibly leading to additional network traffic (that would have been processed using data 42) to be dropped by packet processor 26 while the error in data 42 remain uncorrected. Additionally, this type of memory error detection mechanism (e.g., relying on packet processor 26 to access the fault data) may inherently disrupt traffic processing, as a memory error is detected when the corresponding fault data is actually intended to be used by packet processor 26 to process network traffic.

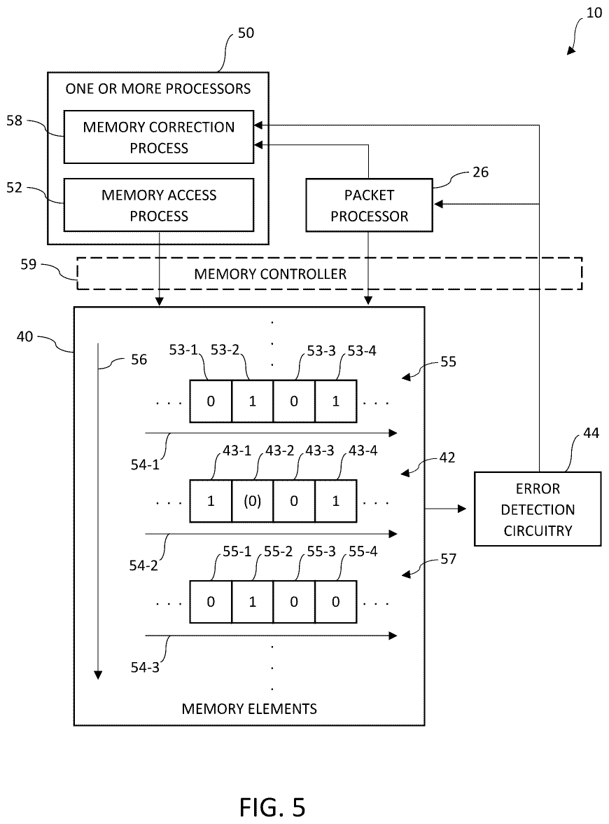

Accordingly, it may be desirable to detect memory error(s) proactively such that memory errors can be detected prior to being accessed for use in processing network traffic by packet processor 26. FIG. 5 is a diagram of illustrative network device processor(s) configured to access memory elements of memory circuitry while the memory circuitry is being actively used for traffic processing by a packet processor.

In particular, network device 10 may include one or more processors 50. These processor(s) 50 may be or include one or more processors of control plane processing circuitry 22, one or more processors (e.g., general processing cores of integrated circuit die 30) integrated with packet processor 26 (e.g., implemented using dedicated packet processing cores of integrated circuit die 30), and/or one or more processors from other discrete integrated circuits of network device 10 (e.g., separate from processing circuitry 22 and 26).

Processor(s) 50 (sometimes referred to as processing circuitry 50) may run (e.g., execute) a memory access process 52 (e.g., by executing software instructions stored on corresponding memory circuitry such as a portion of memory circuitry 24). When executing process 52, processing circuitry 50 may sequentially access memory elements 40 (e.g., of memory circuitry 32 and/or memory circuitry 36) and read the contents (e.g., values at bit positions) therein. In particular, processing circuitry 40 may access (e.g., read) memory elements 40 by memory addresses (e.g., to obtain 8-bit values), by N-bit words where N is any suitable number (e.g., 8, 16, 32, etc.), by double words, or generally by any grouping of one or more bits.

In the illustrative example of FIG. 5, processing circuitry 50, when executing process 52, may access memory elements 40 and the bits therein (e.g., the binary values in corresponding bit positions for each memory address) by going down a first row (e.g., from left to right in the perspective of FIG. 5) as indicated by arrow 54-1, then down a second row as indicated by arrow 54-2, then down a third row as indicated by array 54-3, and so on, generally proceeding in direction 56 after accessing memory elements of a given row. This pattern of accessing (e.g., reading) memory elements 40 performed by processing circuitry 50 is merely illustrative.

In general, processing circuitry 50, when executing process 52, may access memory elements 40 based on any pattern or sequence (e.g., by incrementing memory addresses, by decrementing memory addresses, by a predetermined sequence of memory addresses, by a randomly-selected sequence of memory addresses, etc.) such that the entirety of the memory space (e.g., all or each of memory elements 40) is eventually accessed. If desired, processing circuitry 50, when executing process 52, may repeatedly access the entirety of the memory space any suitable number of times (e.g., one time after another and therefore in a continuous manner, periodically with a regular or irregular periodicity and breaks therebetween, based on one or more trigger conditions being met, and/or based on receiving instructions (commands) to perform memory access).

By simply accessing (e.g., reading) data stored in memory elements 40, processing circuitry 50 may trigger error detection circuitry 44 for memory elements 40 to validate the data being accessed, thereby causing detection of any memory errors in the bit values stored in memory elements 40. Accordingly, processing circuitry 50, when executing process 52, may probe memory elements 40 of the memory circuitry to cause memory error detection through error detection circuitry 44, but may discard the bit values read from memory elements 40. If desired, processing circuitry, when executing process 53 may provide the content read from memory elements 40 to other software process(es) and/or hardware components of network device 10 for further processing.

In the illustrative configuration of FIG. 5 (e.g., similarly to the configuration described in connection with FIG. 4), bit position 43-2 may store a faulty bit value of ‘0’ in data 42 (e.g., thereby causing a faulty value in traffic processing decision data 42 such as a faulty value defining a matching criterion, action, or other content associated with a routing table entry such as a forwarding information base entry or a routing information base entry, an access control list entry, a traffic policy entry, etc.). Rather than leaving the error in data 42 to be undetected until when data 42 is used by packet processor 26 to process corresponding network traffic, processing circuitry, when executing process 52, may access data 42 at a given memory element 40 beforehand or proactively (e.g., as part of the memory access operation sequentially accessing all of the memory elements 40). This accessing of data 42 may trigger the detection and subsequent correction of the value at bit position 43-2 prior to faulty data 42 being used by packet processor 26 to process corresponding network traffic.

In other words, processing circuitry 50, when executing process 52, may access traffic processing decision data 55 containing bits at bit positions 53-1, 53-2, 53-3, and 53-4, may access traffic processing decision data 42 containing bits at bit positions 43-1, 43-2, 43-3, and 43-4, may access traffic processing decision data 57 containing bits at bit positions 55-1, 55-2, 55-3, and 55-4, and may generally sequentially and continuously access different sets of memory elements 40. This accessing of memory elements 40 may cause error detection circuitry 44 to perform validation of data 55, 42, 57, and other stored data (e.g., using error detection bits 46 for the corresponding data as described in connection with FIG. 4).

Because memory access process 52 may be independent of a memory detection and/or memory correction process (e.g., process 58 executing on processing circuitry 50), the accessing of memory elements 40 may continue (proceed without interruption) even when bit positions having memory errors are accessed.

While validating data 55 and 57 may result in a determination of no memory error, validating data 42 may result in a determination of a memory or and cause error detection circuitry 44 to generate and output of an indication of detected memory error. In particular, when processing circuitry 50 accesses (e.g., reads) data 42 (and therefore the faulty value at bit position 43-2) while accessing memory elements 40 down the second row of memory elements, error detection circuitry 44 for memory elements 40 may validate the data 42 being accessed before providing processing circuitry 50 with data 42. During this validation process, error detection circuitry 44 may identify and obtain one or more (expected) error detection bits (e.g., bits 46 shown in and described in connection with FIG. 4) associated with data 42 from storage.

Error detection circuitry 44 may further calculate error detection bit(s) based on the current state (of bits) for data 42, may compare the calculated error detection bit(s) with expected error detection bit(s) 46 to determine whether there is a mismatch between the calculated and expected bits. Responsive to a mismatch, which indicates one or more memory errors in the data (e.g., data 42) being accessed, error detection circuitry 44 may provide an indication of a detected error (e.g., indication 48 shown in and described in connection with FIG. 4) to processing circuitry 50.

In particular, processing circuitry 50 may run (e.g., execute) a memory correction process 58 (e.g., by executing software instructions stored on corresponding memory circuitry such as a portion of memory circuitry 24). The same or different processor(s) 50 may execute processes 52 and 58. Configurations in which processor(s) of control plane processing circuitry 22 execute processes 52 and 58 are sometimes described herein an illustrative example.

Processing circuitry 50, when executing process 58, may obtain an indication of memory error(s) identified by error detection circuitry 44. Consequently, based on the indication (e.g., indicative of the bit position(s) and/or memory address(es) at which the memory error(s) are present), processing circuitry 50, when executing process 58, may replace (e.g., overwrite) the data at the indicated bit position(s) and/or memory address(es) with the correct data (e.g., a copy of which may be maintained by the portion of memory circuitry for control plane processing circuitry 22 or maintained elsewhere).

Processing circuitry 50, when executing process 52, may provide a first mechanism for accessing memory circuitry to facilitate memory error detection, while packet processor 26 may still provide a second mechanism for accessing memory circuitry to facilitate memory error detection (when using the content of the memory circuitry for network processing). Because there is no guarantee that the first mechanism provided by process 52 will detect all memory errors prior to faulty data being accessed by packet processor 26, packet processor 26 may still sometimes access data containing memory error(s).

Accordingly, when packet processor 26 accesses data containing memory error(s), error detection circuitry 44 may similarly provide indication(s) of the detected memory error to packet processor 26. Packet processor 26 may drop the corresponding traffic (if error detection circuitry 44 lacks error correction functionality or if error detection and correction circuitry 44 is unable to correct the multi-bit errors in the data) and may provide the indication of memory error(s) to processing circuitry 50 (e.g., to process 58 executed by processing circuitry 50) to facilitate correction of the memory errors.

In general, because processing circuitry 50 is continuously executing process 52 to continuously access (e.g., read from) different memory elements 40 in a desired sequence or pattern and has the detected function of accessing memory in this manner, a substantial number of memory errors may be detected by this mechanism. In particular, the continuous nature of memory access may be characterized by process 52 (e.g., continuously running as a background process) accessing memory elements one after another with minimal delay therebetween or with a desired substantive delay therebetween (e.g., with a delay less than 1 nanosecond (ns), less than 5 ns, less than 10 ns, less than 100 ns, less than 1 millisecond (ms), less than 100 ms, etc., between sequential access of memory elements). While processing circuitry 50, executing process 52, is sequentially accessing different memory elements 40 (to ultimately access all memory elements 40 that store traffic processing decision data), packet processor(s) 26 may also access memory elements 40 (e.g., stored specific types of traffic processing decision data) conducive to performing normal traffic processing operations. Accordingly, memory access by processing circuitry 50 and by packet processor(s) 26 may occur in parallel (e.g., using different memory access channels) and/or at least in an interleaved manner (e.g., on a shared memory access channel, if multiple memory access channels are not provided).

In some illustrative arrangements, a memory controller such as memory controller 59 (e.g., memory interface circuitry configured to handle memory access) may be coupled between processing circuitry 50 and memory elements 40, between packet processor 26 and memory elements 40, between error detection circuitry and processing circuitry 50, and/or between error detection circuitry 44 and packet processor 26. Accordingly, processing circuitry 50 and/or processor 26 may access (e.g., read from) memory elements 40 using memory controller 59. Similarly, to convey an indication of detected memory error(s) received from error detection circuitry 44 to processing circuitry 50 and/or to packet processor 26, memory controller 59 may raise an interrupt and forward the indication of detected memory error(s) to processing circuitry 50 and/or to packet processor 26.

Memory controller 59 may be integrated with packet processor 26 (and memory circuitry 32 containing memory elements 40 and error detection circuitry 44) on integrated circuit die 30 or may be implemented on a separate integrated circuit die.

If desired, processing circuitry 50 may directly (e.g., without an intervening controller 59) access memory elements 40, packet processor 26 may directly access memory elements 40, error detection circuitry 44 may directly convey any detected memory errors to processing circuitry 50, and/or error detection circuitry 44 may directly convey any detected memory errors to packet processor 26. These arrangements are merely illustrative and may depend on the implementation of processing circuitry 50, packet processor 26, memory elements 40, error detection circuitry 44, memory controller 59, and/or other components of network device 10.

Memory access process 52 (e.g., when executed by processing circuitry 50) may generally access (e.g., read) the contents of the entire array of memory elements 40 over time to facilitate any possible memory error detection across the entirety of the memory space. In some configurations, the order of accessing the contents of the entire array of memory elements 40 may be non-preferential or unbiased with respect to the content stored in memory elements 40. However, if desired, memory access process 52 (e.g., when executed by processing 50) may preferentially access certain content in certain memory elements first, last, and/or in other orders of preference, may only access certain content in certain memory portion(s) without accessing other content in other memory portion(s), or may generally exhibit other types of preferential behavior based on memory allocation and/or the content stored therein.

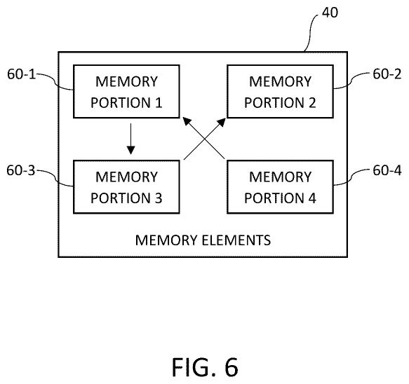

An illustrative order for preferential access of memory circuitry is shown in FIG. 6. In the example of FIG. 6, memory elements 40 (e.g., the same memory circuitry 40 as in FIG. 5) may be organized into four illustrative memory portions 60-1, 60-2, 60-3, and 60-4. In one illustrative example, processing circuitry 50, when executing process 52, may access all memory elements in memory portion 60-4, then access all memory elements in memory portion 60-1, then access all memory elements in memory portion 60-3, and finally access all memory elements in memory portion 60-2.

In particular, the order of accessing different memory portions 60 may be based on the degree of criticality of the stored content in each memory portion, may be based on the frequency of use (e.g., by packet processor 26) of the stored content in each memory portion, and/or may be based on other criteria (e.g., user input). In the above-mentioned illustrative example, memory portion 60-4 may store the most critical content, the most frequently used content, and/or generally content most preferred to be protected from memory errors, while memory portion 60-2 may store the least critical content, the least used content, and/or generally content least preferred to be protected from memory errors. Memory portion 60-1 stores content somewhere in between the content stored at memory portions 60-4 and 60-3 in terms of criticality, use frequency, and/or general preference, and memory portion 60-3 stores content somewhere in between the content stored at memory portions 60-1 and 60-2 in terms of criticality, use frequency, and/or general preference.

The specific examples for different orders and manners of memory access, for the values of bits at different bit positions, the flipping of a single bit from a value of ‘1’ to a value of ‘0’ for a memory error, and other specific details described in connection with FIGS. 4-6 are merely illustrative, and are non-limiting. The orders and manners of memory access, the values of bits at different bit positions, the flipping of bits for memory errors, and other such details may generally differ from the examples described in connection with FIGS. 4-6 in other arrangements.

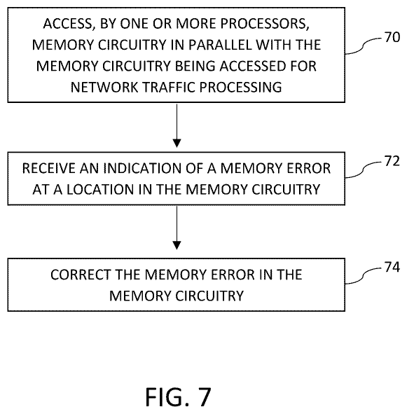

FIG. 7 is a flowchart of illustrative operations for proactively detecting memory error(s). Configurations in which the operations described in connection with FIG. 7 are performed by one or more network devices 10 (e.g., as described in connection with FIGS. 1-6) are sometimes described herein as illustrative examples. If desired, other suitable computing devices in the networking system of FIG. 1 may similarly perform the operations described in connection with FIG. 7.

The illustrative operations described in connection with FIG. 7 may generally be performed using respective processing circuitry (e.g., one or more processors) by a computing device (e.g., a network device 10) by executing, on the processing circuitry, software instructions stored on corresponding memory circuitry (e.g., non-transitory computer-readable storage media) of the computing device.

At block 70, one or more processors (e.g., processing circuitry 50 when executing memory access process 52 in FIG. 5) may access memory circuitry (e.g., memory circuitry 32 and/or memory circuitry 36) in parallel with the memory circuitry being accessed for network traffic processing (e.g., by packet processor(s) 26). In particular, memory access by the one or more processors may be independent of memory access by packet processor(s) 26. Whereas the one or more processors may access the memory circuitry to perform the dedicated function of probing different portions of the memory circuitry to induce the detection of memory errors therein, the packet processor(s) may access selectively portions of the memory circuitry mainly to facilitate the processing of network traffic (e.g., using select traffic processing decision data stored in the memory circuitry). If desired, access to the memory circuitry by the one or more processors and the packet processor(s) may be provided using (e.g., through) a memory controller or other memory interface circuitry.

The one or more processors may access the different portions of the memory circuitry in any suitable manner (e.g., based on a particular sequence of memory addresses, based on a particular pattern on a memory map, preferentially accessing some portion of the memory circuitry before or instead of other portions of the memory circuitry, etc.). In some illustrative configurations described herein as an example, all portions of the memory circuitry storing traffic processing decision data may be accessed at least once in a particular memory access cycle to provide coverage against memory errors for the entire memory space. If desired, the one or more processors may repeatedly (e.g., continuously) access the portions of the memory circuitry multiple times across multiple (continual) cycles to persistently detect any possible memory errors.

At block 72, the one or more processors (e.g., processing circuitry 50 when executing memory correction process 58 in FIG. 5) may obtain (e.g., receive) an indication of a memory error at a location in the memory circuitry. In particular, the memory error may be detected by error detection circuitry for the memory circuitry (e.g., using error detection bits). The obtained indication of the memory error may be based on the detection of the memory error by error detection circuitry. In one example, the error detection circuitry may directly convey the indication to the one or more processors. In another example, the error detection circuitry may convey an indication of the memory error to a memory controller or other memory interface circuitry, which may in turn provide a corresponding indication of the memory error (e.g., through an interrupt message) to the one or more processors (and/or the packet processors, if appropriate).

At block 74, the one or more processors (e.g., processing circuitry 50 when executing memory correction process 58 in FIG. 5) may correct the memory error in the memory circuitry. In particular, the indication of the memory error obtained at block 72 may include identifying information for the memory error such as the location (e.g., the address) of the memory error, the type of the memory error (e.g., single-bit flip, double-bit flip, etc.), the type of stored data affected by the memory error, etc. Based on the identifying information, the one or more processors may overwrite (e.g., replace) the faulty data with the appropriate (e.g., originally programmed) data, thereby correcting the memory error.

The methods and operations described above in connection with FIGS. 1-7 may be performed by the components of the network device(s) (e.g., network device 10) or other computing equipment using software, firmware, and/or hardware (e.g., dedicated circuitry or hardware). Software code for performing these operations may be stored on non-transitory computer-readable storage media (e.g., tangible computer-readable storage media) stored on one or more of the components of the network device(s) or other computing equipment. The software code may sometimes be referred to as software, data, instructions, program instructions, or code. The non-transitory computer-readable storage media may include hard drives (electro-mechanical data storage devices), other non-volatile memory such as solid-state drives, non-volatile random-access memory (NVRAM), removable flash drives or other removable media, and/or volatile memory such as random-access memory or other types of volatile memory. Software stored on the non-transitory computer-readable storage media may be executed by processing circuitry on the network device(s) or other computing equipment.

The foregoing is merely illustrative and various modifications can be made to the described embodiments. The foregoing embodiments may be implemented individually or in any combination.

What is claimed is:

1. A network device comprising:
a packet processor configured to process network traffic;
memory circuitry having error detection circuitry, coupled to the packet processor, and configured to store data for processing the network traffic; and
processing circuitry coupled to the memory circuitry and configured to:
access the memory circuitry;
obtain, in response to accessing the memory circuitry, an indication of a memory error in the data prior to the data being accessed by the packet processor to process the network traffic; and
correct the memory error.

2. The network device defined in claim 1, wherein the processing circuitry is configured to access the memory circuitry in parallel with the packet processor accessing the memory circuitry to process the network traffic.

3. The network device defined in claim 1, wherein the processing circuitry is configured to access the memory circuitry by sequentially accessing memory elements in the memory circuitry.

4. The network device defined in claim 3, wherein a given memory element in the sequentially accessed memory elements stores a value that is part of the data and that contains the memory error and wherein the processing circuitry is configured to obtain the indication of the memory error in response to accessing the given memory element.

5. The network device defined in claim 4, wherein the error detection circuitry is configured to detect the memory error when validating the value at the given memory element in response to the processing circuitry accessing the given memory element and wherein the obtained indication of the memory error is based on the memory error being detected by the error detection circuitry.

6. The network device defined in claim 3, wherein the processing circuitry is configured to access the memory circuitry by accessing each of the memory elements in the memory circuitry.

7. The network device defined in claim 1, wherein the stored data for processing the network traffic comprises data for a routing table or data for an access control list.

8. The network device defined in claim 1, wherein the processing circuitry comprises control plane processing circuitry.

9. The network device defined in claim 8, wherein the memory circuitry comprises on-chip memory integrated with the packet processor on an integrated circuit die.

10. The network device defined in claim 9, wherein the on-chip memory comprises static random-access memory.

11. The network device defined in claim 8, wherein the memory circuitry comprises discrete memory on an integrated circuit die separate from an integrated circuit die implementing the packet processor.

12. The network device defined in claim 11, wherein the discrete memory comprises dynamic random-access memory.

13. The network device defined in claim 1 further comprising:
a memory controller, wherein the processing circuitry is configured to access the memory circuitry using the memory controller and is configured to obtain the indication of the memory error in the data from the memory controller.

14. The network device defined in claim 13, wherein the memory controller is integrated with the packet processor on an integrated circuit die.

15. A network device comprising:
memory circuitry having error detection circuitry and configured to store traffic forwarding decision data;
data plane processing circuitry coupled to the memory circuitry and configured to access the memory circuitry for processing network traffic; and
control plane processing circuitry coupled to the memory circuitry and configured to sequentially access memory elements of the memory circuitry while a portion of the memory circuitry is accessed by the data plane processing circuitry to process the network traffic.

16. The network device defined in claim 15, wherein the control plane processing circuitry is configured to obtain an indication of a memory error based on a given memory element, in the memory elements, containing the memory error being accessed by the control plane processing circuitry.

17. The network device defined in claim 16, wherein the data plane processing circuitry and the memory circuitry are implemented on a common integrated circuit die.

18. The network device defined in claim 15, wherein the control plane processing circuitry is configured to sequentially access memory elements of the memory circuitry by accessing each of the memory elements of the memory circuitry.

19. A network device comprising:
a packet processor configured to process network traffic;
memory circuitry having error detection circuitry and accessible by the packet processor when processing the network traffic; and
processing circuitry coupled to the memory circuitry and configured to probe the memory circuitry for one or more memory errors while the packet processor accesses the memory circuitry to process the network traffic.

20. The network device defined in claim 19, wherein the processing circuitry is configured to probe the memory circuitry for one or more memory errors by accessing memory elements of the memory circuitry in a given order.
